(19) United States
(12) Patent Application Publication
(10) Pub. No.: US 2011/0187253 A1
(43) Pub. Date: Aug. 4, 2011

(54) FITTING FOR HOUSEHOLD APPLIANCES AND LUBRICANT

(76) Inventors: Peter Jaehrling, Buende (DE); Willi Grigat, Guetersloh (DE)

(21) Appl. No.: 13/122,485

(22) PCT Filed: Oct. 22, 2009
(86) PCT No.: PCT/EP09/63933

§ 371 Date: Apr. 4, 2011

(30) Foreign Application Priority Data
Oct. 24, 2008 (DE) 10 2008 053 022.0
Feb. 16, 2009 (DE) 10 2009 009 124.6

(51) Int. Cl. C10M 103/02; C10M 103/00; A47B 88/10; E05D 11/02

(52) U.S. Cl. 312/334.1; 508/155; 508/125; 508/100; 16/274

(57) ABSTRACT

The invention relates to a fitting, for example a drawer slide for household appliances, comprising two rails that can move relative to one another and that are slid toward one another by way of rolling elements. In the process, the tracks (6, 8) of the rolling element (4) are lubricated at the rails (2, 3) at least in areas by way of a lubricant (7) comprising a boronitride and/or polysiloxane. This facilitates an efficient use of lubricant (7), which is also stable at high temperatures. The invention further relates to a lubricant, in particular for fittings in household appliances, that is stable at temperatures of over 600° C. and can be used in wet and humid areas.

The present invention relates to a fitting, for example a drawer slide, especially for an oven, comprising at least two rails that can move relative to one another and are slid on each other by way of rolling elements, and to a lubricant.

In the area of drawer slides with application in higher temperature ranges, many of the known lubricants will reach the limits of material resilience. Many of the known fluid lubricants such as polyfluorinated compounds for example can no longer be used in the higher temperature ranges despite outstanding sliding and lubricating properties.

That is why it is a technical challenge to provide a respective fitting, especially a drawer slide, which constantly offers good lubricating and sliding properties beneath room temperature and also at temperatures of up to 600° C. Furthermore, it is necessary to provide chemical resistance of coating and a cost-effective manner of producing and applying the same.

EP 1589291 A1 discloses a generic drawer slide which comprises rolling elements which are attached to a rolling element cage. The rolling element cage has a lubricant layer which provides among other things the integration of boron nitride in a lacquer. Since boron nitride is used in areas only for cost reasons in which its special material properties are absolutely necessary, the most important aspect in the use of this compound is especially the best possible cost-optimized application. Coating over a large surface area as in EP 1589291 A1 is therefore not appropriate.

It is the object of the present invention to provide a fitting, especially a drawer slide and a lubricant, which enable smooth guidance of the rails both when used at low temperatures and at high temperatures over a long period of time.

This object is achieved by a drawer slide with the features of claim 1, a lubricant with the features of claim 16 and a fitting with the features of claim 27.

As a result of the solution in accordance with the invention, the lubricant containing boron nitride and/or polysiloxane can be applied at least in sections on the considerably smaller areas of the tracks. This allows purposeful lubrication in combination with low material consumption.

Hexagonal boron nitride has proven to be an optimal lubricant and sliding agent in applications with higher temperatures. With the exception of molten alkalis and alkaline solutions, it is chemically inert and resistant to oxidation. The structure of boron nitride is substantially similar to that of graphite and from a temperature of 900° C. the boron nitride converts into cubic β-boron nitride.

The application of the lubricant preferably occurs in the form of a lubricant paste, suspension or as a powder. The lubricant can thus be used for industrial series production. Moreover, these applications allow a very precise selection and coating of the application surfaces.

According to a preferred embodiment, the lubricant mixture is a mixture of boron nitride, graphite and high-temperature grease, with a mass fraction w (boron nitride) of between 5% and 30%, preferably a mass fraction w (boron nitride) of between 10% and 20%. Both the use of the relatively inexpensive graphite as a further lubricant component and high-temperature grease as a matrix and carrier substance additionally support the sliding and lubricating properties of boron nitride. Whereas the graphite emits incorporated water molecules during longer heating periods, which briefly reduces its lubricating effect, this is maintained in boron nitride even at high temperatures, especially over 200° C.

Furthermore, the lubricant can preferably contain a silicone paste, a silicone grease and/or a silicone oil advantageously as a polysiloxane compound which does not incinerate at temperatures above 300° C., i.e. pyrolysis operation of ovens for example. The consistency between these embodiments can be varied by mixing.

In accordance with the claims 8 to 9, the lubricant mixture can contain molybdenum sulphide and polytetrafluoroethylene for supporting the lubricating effect, especially in applications under 300° C.

An aftertreatment after the application of the lubricant by vibratory grinding allows better distribution and adherence of the lubricant and sliding agent on the metallic base.

In an advantageous embodiment, the lubricant has a temperature resistance of over 600° C. which enables an application in the area of cooking ovens and their cleaning by pyrolysis for example.

It is further advantageous if the lubricant contains a thixotropy, with its viscosity decreasing in such pastes under mechanical action and the original viscosity returning again only after prolonged standing. In this way, the pastes can be spread relatively easily over the surface of the drawer slides under pressure. This is the case in BNC pastes for example.

The viscosity of a lubricant without the addition of solids advantageously lies in the range of between 50 to 1500 mm² per second, preferably 100 to 1000 mm² per second. This allows applying the low-viscous and medium-viscous compound without having the lubricant flow out at the ends of the tracks.

It is further advantageous if the lubricant is hydrophobic to such an extent that contamination of the lubricant with bacteria or fungi is excluded.

The low surface tension in conjunction with a distinct surface activity at 25° C. of 20 to 22 mN/m, preferably 20.9 to 21.2 mN/m, allows complete wetting of a larger planar base during application despite a high viscosity of a lubricant.

Depending on the carrier substance, it is decomposed during pyrolysis mainly in water and carbon dioxide. As a result of the actuation of the drawer slide during use by the user, the boron nitride and the graphite content in the lubricant mixture is distributed evenly in the tracks of the drawer slide with the help of the carrier material. After the decomposition of the carrier substance during pyrolysis, at least the boron nitride remains in the tracks of the drawer slide and allows smooth operation of the drawer slide, which thus continues to be lubricated. As a result of the mechanical loading prior to pyrolysis, the boron nitride and graphite content in the mixture is worked into the tracks of the drawer slide.

The lubricant in accordance with the invention is especially suitable for lubricating fittings in domestic appliances such as ovens or refrigerators, which is due to its application range of approximately −50° C. to approximately 600° C. The application of the lubricant can also be considered in other areas, especially in areas where suitability for foodstuff is required. It is also possible to lubricate hinges, folding mechanisms or other movable parts especially in domestic appliances in addition to the drawer slides.

In order to meet all requirements placed on the carrier substance with respect to its suitability for foodstuffs, lubricants are preferably used which meet the FDA guideline 21 CFR 178.3570 (US Food and Drug Administration).

Furthermore, the lubricants should be registered by the NSA (National Sanitation Foundation) in H1 category. Reference is hereby also made to ISO 21469.

In the USA, approval might also be necessary by the US-DA (United States Department 30 of Agriculture) according to US-DA-H1. Notice must be taken that the guiding regulation should be guideline 21 CFR 178.3570.

The employed lubricants preferably also fulfill the hygienic requirements according to the German version DIN EN ISO 21469:2006.

The invention will be explained below in closer detail by reference to an embodiment shown in the drawings, wherein:

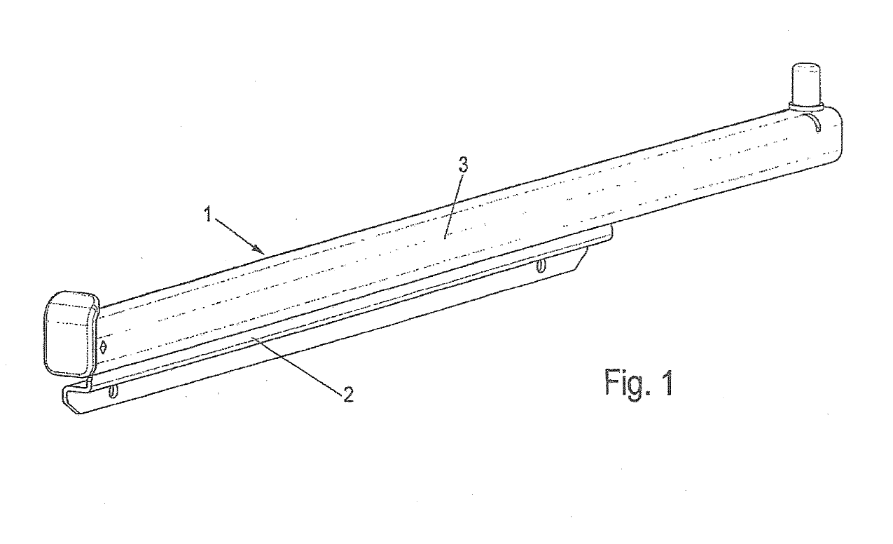

FIG. 1 shows a perspective view of a drawer slide in the retracted position;

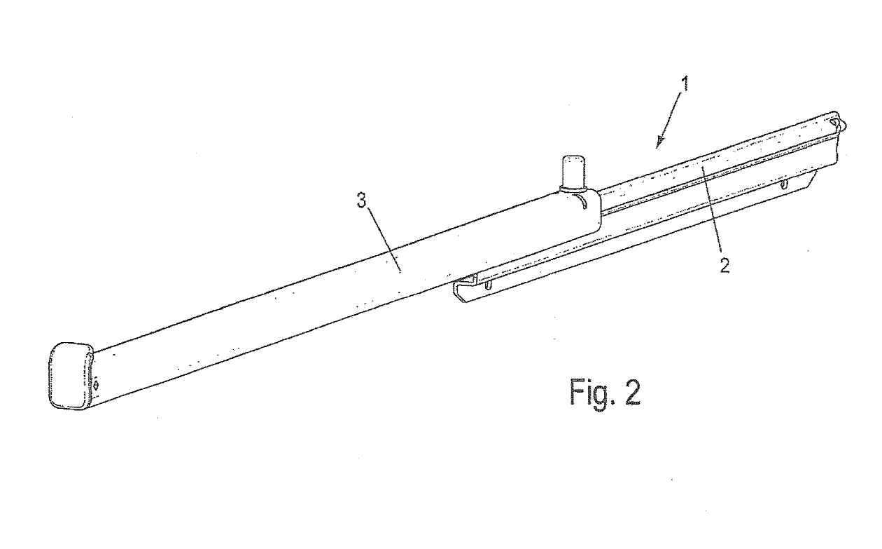

FIG. 2 shows a perspective view of the drawer slide of FIG. 1 in the extended position;

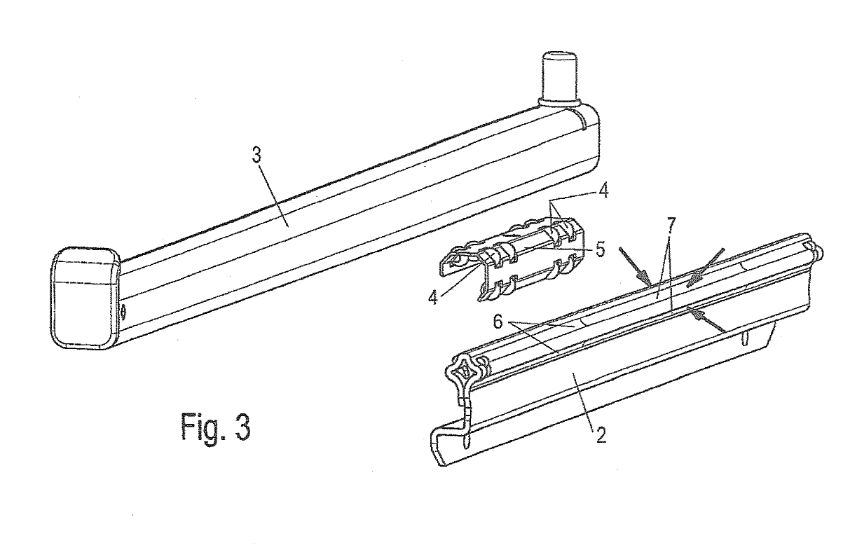

FIG. 3 shows an exploded view of the drawer slide of FIG. 1;

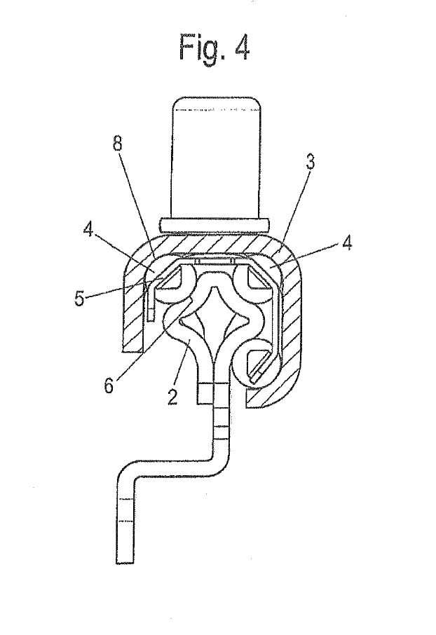

FIG. 4 shows a sectional view of the drawer slide of FIG. 1, and

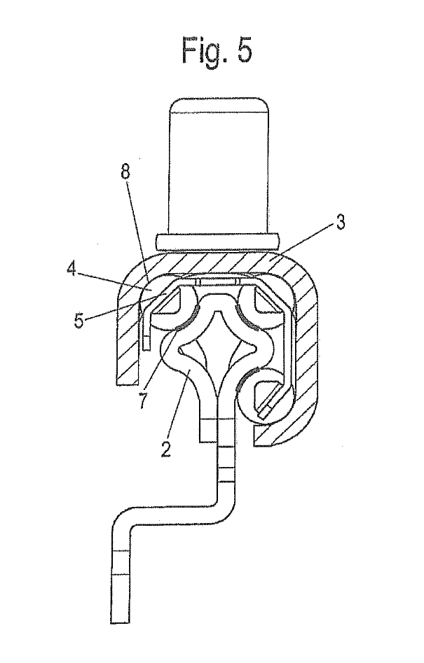

FIG. 5 shows a sectional view of the drawer slide of FIG. 1.

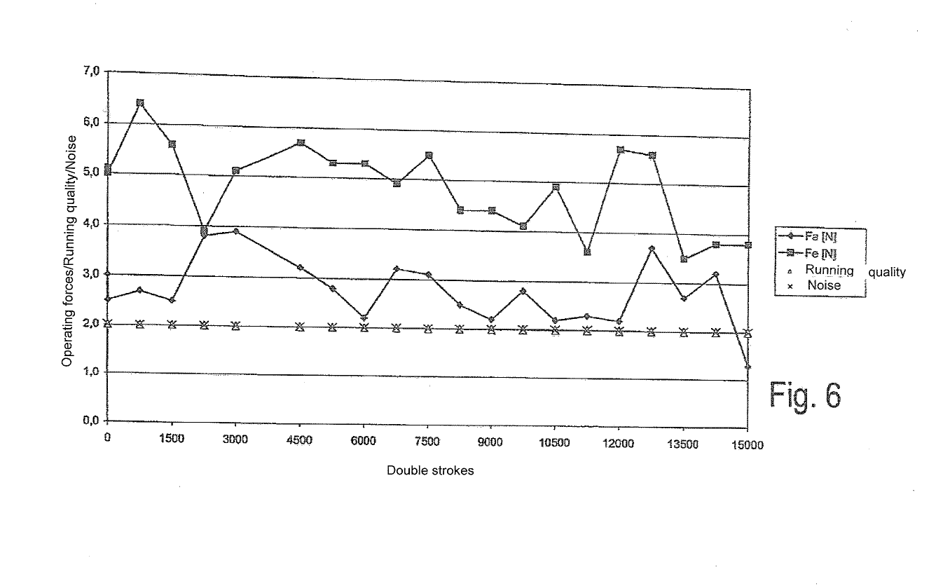

FIG. 6 shows a diagram illustrating the effect on the drawer slide as caused by the invention.

A drawer slide 1 comprises a guide rail 2 and a running rail 3 which is movable relative to the guide rail. The guide rail 2 and the running rail 3 are made of bent sheet steel.

The guide rail 2 can be fixed to a side wall of an oven and a cooking-product carrier can be placed in a respective manner on the running rail 3. The running rail 3 is displaceably held on the guide rail 2 via rolling elements 4. For this purpose, the guide rail 2 comprises several tracks 6 for the spherical rolling elements 4 which are held in a rolling element cage 5.

In order to ensure smooth guidance of the running rail 3, a lubricant 7 is applied to a section of the tracks 6. When the rolling elements 4 roll on the sections with the lubricant 7, it will spread over the entire track 6 on the guide rail 2 and on the tracks 8 which are arranged on the running rail 3.

The illustrated embodiment describes a drawer slide with a running rail 3 and a guide rail 2. It is obviously also possible to arrange the drawer slide as a fully extendable drawer slide and to provide a middle rail between the guide rail 2 and the running rail 3.

The application of a lubricant with boron nitride and/or graphite can occur in the following ways:
Coating of the tracks with a boron nitride sliding lacquer
Application of the boron nitride as a sliding paste or suspension
Application of the boron nitride in the form of powder by vibratory grinding
Mixtures of boron nitride and high-temperature grease, with the boron nitride remaining as the solid lubricant in the tracks after pyrolysis
Mixtures of boron nitride with molybdenum sulphide, graphite and PTFE are possible
Mixtures of boron nitride with a polysiloxane
Mixtures of graphite, polysiloxane and water
Mixtures of graphite with a polysiloxane
Mixtures of graphite, boron nitride and a polysiloxane

Lubricants and sliding agents are boron nitride and graphite for example which will spread very easily on a surface under friction as a result of their hexagonal structure and will thereupon prevent friction.

The mixture of powder made of boron nitride BN and graphite C in the ratio by mass of 10% BN/90% C to 80% BN/20% C leads to a powder with different greyscales. The BNC mixture has tribological and other physical and chemical properties which enable a use as a dry lubricant with hygroscopic properties in the area of domestic appliances.

The powder has sufficient sliding properties after being subjected to high temperatures as can occur in pyrolysis operation (self-cleaning process in the oven around 600° C.), and also at freezing temperatures in refrigerators. The temperature stresses on the mixed substances have different effects. At relevant temperatures in ovens for example, sliding friction is assumed by both substances. In the vapor-containing range up to 100° C. and also under high immediacy of air, the main lubricating effect lies with the graphite which provides its lubricating effect best under the presence of humidity. The lubricating effect lies mainly in the BN in the freezing temperature range and at temperatures of 400° C.

The BNC mixture can also be further processed with different methods. Possible application methods are blowing onto the surface as a powder with or without carrier gas, spraying with a wet carrier, coating with a brush and a wet carrier, mixing in via a rolling technique or immersion in a wet carrier. A spraying method by nozzles can also be considered, even in the case of a pasty consistency of the mixture.

If the BNC powder is mixed with a wet carrier such as water, alcohol or food-grade oils or greases, a suspension (heterogeneous solid/with mixture), a dispersion (homogeneous solid/fluid mixture) or an emulsion (heterogeneous fluid/fluid mixture) is obtained depending on the wet carrier. The subsequent mixture can consist of solid/fluid or fluid/fluid or gaseous/fluid substances which will then be further processed with the methods as mentioned above.

Both boron nitride as well as carbon has hexagonal and also cubic modifications of their crystalline structure, with a hexagonal modification of the carbon being known as graphite and the cubic modification being known as diamond. Similar to the graphite, the hexagonal boron nitride has a layered structure, with the superimposed layers being relatively easily displaceable with respect to one another and thus causing a sliding and lubricating effect. These synergy effects between graphite and boron nitride allow a mixture in the mentioned ratios.

The performance of the applied BNC—Si lubricants is based on a physical and tribo-chemical effect for the use in slides and hinges. It occurs especially advantageously in the range of −50° C. to +220° C. A virtually constant viscosity is obtained within the mentioned temperature range under a constantly high mechanical load. The viscosity of the BNC—Si lubricants lies in the range of between 100 to 1000 mm² per second, is determined at 25° C. according to DIN 51562 and categorizes the BNC—Si lubricants in the category of low to medium viscous substances. As a result of the high hydrophobia, the lubricants form a protection from corrosion, leading neither to bleeding out in the temperature range, nor to oil discharges, even over prolonged periods of time. The viscosity data relate to lubricants without the addition of solids.

The following properties need to be mentioned in connection with the temperature resistance of BNC—Si:
The viscosity temperature coefficient lies between 0.5 and 0.7, preferably between 0.6 and 0.62;
the heat of evaporation lies up to 200° C. between 150 and 300 J/g, preferably between 220 and 240 J/g;
the boiling point at 0.5 mbar lies between 100 and 300° C., preferably between 150 and 230° C.;
the pour point according to DIN 51583 lies between −50 and 10° C., preferably between −30 and −10° C.;
the flash point lies according to DIN 51376 between 230 and 370° C., preferably between 275 and 321° C.;
the ignition point lies according to DIN 51794 over 400° C., preferably over 420° C.;
the dropping point lies according to AST-D-445 between −80° C. and −30° C., preferably between −65° C. and −50° C.

Additional disturbing noises such as squeaking do not occur with the use of BNC—Si lubricants. A high pressure absorption capacity comes to bear in this case. Accordingly, a drawer slide provided with a BNC silicone lubricant will always show consistently good sliding properties even under a high mass load which is caused by a cooking-product carrier for example.

A lubricating film remains after the pyrolysis treatment of the BNC paste which ensures functionality of the slides.

The application of the BNC—Si lubricant can occur by means of silicone pastes, silicone greases and silicone oils. The low surface tension in conjunction with a distinct surface activity at 25° C. of 20 to 22 mN/m, preferably 20.9 to 21.2 mN/m, allows the complete wetting of a base with a large surface after application. Further solvents can be added to the lubricant in order to provide variability to the viscosities of the BNC—Si lubricants.

A BNC—Si lubricant layer is highly water-repellent and chemically inert against plant oils, mineral oils, gases, diluted acids and lyes, and most aqueous solutions. Contamination of the lubricant with bacteria or fungi is excluded as a result of its highly hydrophobic properties. In addition, BNC—Si lubricants are resistant to radiation, resistant to oxidation, not poisonous, non-flammable and physiologically inert and odorless.

The coloring of the lubricant can be set by the BNC ratio.

All ingredients of the BNC—Si lubricant correspond to USDA and FDA regulations and are therefore suitable for use in the food sector.

Moreover, according to the German Act on Foodstuffs and Consumer Goods (§5, Section 1, Subsection 1 of 15 Aug. 1974, Federal Law Gazette 1945) there are no objections to the use of silicone carriers and phenylmethyl silicone oils with a viscosity of ≧100 mm²/s at 20° C. in the food sector.

FIG. 6 shows the measured values in the form of a diagram, by means of which the properties of a BNC—Si lubricant can be described which was applied as a lubricant onto an electroplated aluminum surface.

During the test run, the result of which are listed in the diagram, a drawer slide provided with a BNC—Si lubricant was tested for the following properties by frequent actuation of the drawer slide:
a) Applied force in pulling out the drawer slide (Fa) in N
b) Applied force in pushing in the drawer slide (Fe) in N
c) The running quality, assessed by a trained examiner by means of an ordinal scale
d) Noises, assessed by a trained examiner by means of an ordinal scale

During the test, the drawer slide was tested for wear and tear with 15,000 double strokes, which means pulling out and pushing in the drawer slide. At the beginning of the measurement, the drawer slide was subjected to several pyrolysis cycles of 500° C., which were repeated once after each 750 double strokes. This was done for simulating the conditions which the drawer slide is subjected to in ovens with pyrolysis operation.

The drawer slide was loaded during this test with a weight of 11 kg and subjected to a total of 100 pyrolysis sequences.

The forces applied in pulling out the drawer slide were in the range of between 3.5 and 6.5 N, with fluctuations occurring in a relatively constant manner about an average value of 5.0 N and no increase or decrease in the applied force was observed on average.

Similar observations can be made in connection with the forces which need to be applied for pushing in the drawer slide. Comparably high fluctuations around an average value of 2.3 N occur in a range of 1.5 to 4.0 N.

The results of the measurement show a constant running quality with quiet running with low application of force (classification 1 to 7, with 1 corresponding to the highest running quality with smooth running, and 7 corresponding to the lowermost running quality with blocking and jarring running).

The results of the measurement further show constant mobility with a quietly knocking run (classification 1 to 7, with 1 corresponding to a moderate noise development, and 7 corresponding to a disturbing booming noise development).

The following picture was obtained from the material tests:

| Test | | | Double | Pyrolysis | | |
|---|---|---|---|---|---|---|
| No. | Lubrication | Composition | strokes | cycles | Test result | Test result |
| 1 | BN:C:NO | 25:25:50 | 17,500 | 60 | Grey coloring | Running test |
| | paste | BNC:Oil | | | of | was undisturbed |
| | | | | | surface | |
| 2 | BN:C:Si | 25:25:50 | 15,000 | 40 | Grey coloring | Running test |
| | paste | | | | of | was undisturbed |
| | Series status | | | | surface | |
| | degreased | | | | | |
| 3 | BN:C:NO | 48:48:4 | 15,000 | 44 | Grey coloring | Running test |
| | paste | | | | of | was undisturbed |
| | Series status | | | | surface | |
| | degreased | | | | | |
| 4 | C:Si:H₂O | 36:2:62 | 15,000 | 18 | Grey coloring | Running test |
| | paste | | | | of | was undisturbed |
| | Series status | | | | surface | |
| | degreased | | | | | |
| 5 | BN:C:PFPE | 25:25:50 | 15,000 | 40 | Grey coloring | Running test |
| | | | | | of | was undisturbed |
| | | | | | surface | |
| 6 | BN:C:Si | 25:25:50 | 15,000 | 100 | Grey coloring | Running test |
| | paste | | | | of | was undisturbed |
| | Series status | | | | surface | |
| | degreased | | | | | |

The compositions mentioned in the table relate to mass fractions by percent. Si characterizes the mass fractions by percent of silicon oils or silicone pastes. NO characterizes the mass fractions by percent of native oils. PFPE characterizes the mass fractions by percent of perfluoroethyl oxide oil.

The composition under test numbers two and six are especially preferable. This formulation does not show any changes in the running properties or the running quality even after 100 cleaning cycles, according to test number six.

The applied silicone oil consists in this exemplary composition substantially of polydimethyl siloxane. Furthermore, the particle size of the employed hexagonal boron nitride is to approximately 5 μm and the particle size of the employed graphite is also approximately 5 μm. A particle size of approximately 5 μm shows an especially good lubricating property. Particle sizes in the range of 0.1 μm to 8 μm were examined.

As a result of the particle size and the roughness of the fiction parties, the boron nitride and graphite particles roll into the surfaces. The rolled-in BNC particles can no longer be removed from the drawer slides in the dishwasher already after 100 double strokes. After 25 cleaning applications in the intensive cleaning program, the drawer slides are still fully functional. Dishwasher resistance is thus achieved. Domestic and industrial dishwashers were used in the examination of the dishwasher resistance.

Both the particle sizes of the boron nitride as well as the graphite are subject to a certain fluctuation range. Moreover, the particle sizes can fluctuate between 0.1 to 500 μm depending on the composition of the mixtures.

The use of synthetic graphite has proven to be advantageous because it is more even in structure and grain size distribution. The fraction with the particle size of approximately 5 μm was preferably used.

Several possibilities for compositions of lubricants in the high-temperature range (in mass fractions w) are mentioned below:

### 1^{st} Mixture:

| | |
|---|---|
| Graphite | 20 to 50%, preferably 30 to 40% |
| Silicone oil | 0.5 to 5%, preferably 1 to 3% |
| Water | 45 to 79.5%, preferably 57 to 69% |

### 2^{nd} Mixture:

| | |
|---|---|
| Boron nitride | 10 to 40%, preferably 20 to 30% |
| Graphite | 10 to 40%, preferably 20 to 30% |
| Silicone oil | 20 to 80%, preferably 40 to 60% |

(Viscosity achieved is 1000 mm²/s in this case)

### 3^{rd} Mixture:

| | |
|---|---|
| Boron nitride | 10 to 40%, preferably 20 to 30% |
| Graphite | 10 to 40%, preferably 20 to 30% |
| Perfluoroethyl oxide oil | 20 to 80%, preferably 40 to 60% |

### 4^{th} Mixture:

| | |
|---|---|
| Boron nitride | 10 to 40%, preferably 20 to 30% |
| Graphite | 10 to 40%, preferably 20 to 30% |
| Olive oil | 20 to 80%, preferably 40 to 60% |

(Viscosity achieved is 100 mm²/s in this case)

### 5^{th} Mixture:

| | |
|---|---|
| Boron nitride | 30 to 70%, preferably 40 to 60% |
| Graphite | 30 to 70%, preferably 40 to 60% |
| Olive oil | 1 to 10%, preferably 1 to 5% |

### 6^{th} Mixture:

| | |
|---|---|
| Boron nitride | 15 to 35%, preferably 20 to 30% |
| Graphite | 15 to 35%, preferably 20 to 30% |
| Olive oil | 30 to 70%, preferably 40 to 60% |

### 7^{th} Mixture:

| | |
|---|---|
| Graphite | 30 to 70%, preferably 40 to 60% |
| Silicone oil | 30 to 70%, preferably 40 to 60% |

### 8^{th} Mixture:

| | |
|---|---|
| Boron nitride | 30 to 70%, preferably 40 to 60% |
| Perfluoroethyl oxide oil | 30 to 70%, preferably 40 to 60% |

### 9^{th} Mixture:

| | |
|---|---|
| Boron nitride | 30 to 70%, preferably 40 to 60% |
| Silicone oil | 30 to 70%, preferably 40 to 60% |

Other oils with a high share of unsaturated fatty acids and other native oils can be used as an alternative to olive oils.

The viscosity of the fluid lubricant can be varied without departing from the scope of the inventive idea.

Further lubricating greases which meet the FDA purity requirements of the US Food and Drug Administration according to guideline 21 CFR 178.3570 can also be used. The same applies to lubricating greases which were registered by the NSF (National Sanitary Foundation) in the H1 category, with reference additionally being made to ISO 21469.

The lubricant thus meets the test standards of DIN 21469:2006 as a food-grade lubricant.

### LIST OF REFERENCE NUMERALS

1 Drawer slide
2 Guide rail
3 Running rail
4 Rolling element
5 Rolling element cage
6 Track
7 Lubricant
8 Track

1. A drawer slide (1), especially for an oven, comprising at least two rails (2, 3) that can move relative to one another and are slid on each other by way of rolling elements (4), characterized in that the tracks (6, 8) of the rolling elements (4) are lubricated at the rails (2, 3) at least in areas by way of a lubricant (7) containing boron nitride and/or a polysiloxane.

2. A drawer slide according to claim 1, characterized in that the lubricant (7) is applied as a sliding paste, dispersion or suspension.

3. A drawer slide according to claim 1, characterized in that the lubricant (7) is powdery.

4. A drawer slide according to claim 1, characterized in that the lubricant (7) contains a mixture of boron nitride and graphite.

5. A drawer slide according to claim 4, characterized in that boron nitride is contained in a mass fraction w (boron nitride) of between 5% and 30%, preferably a mass fraction w (boron nitride) of between 10% and 20%.

6. A drawer slide according to claim 1, characterized in that the lubricant (7) contains a high-temperature grease.

7. A drawer slide according to claim 1, characterized in that the lubricant (7) contains a food-grade grease.

8. A drawer slide according to claim 1, characterized in that the lubricant (7) contains a silicone paste, silicone grease and/or silicone oil as a silicone compound.

9. A drawer slide according to claim 1, characterized in that the lubricant (7) contains molybdenum sulphide.

10. A drawer slide according to claim 1, characterized in that the lubricant (7) contains polytetrafluoroethylene (PTFE).

11. A drawer slide according to claim 1, characterized in that the lubricant (7) is incorporated by vibratory grinding.

12. A drawer slide according to claim 1, characterized in that the lubricant (7) has a temperature resistance of over 600° C.

13. A drawer slide according to claim 1, characterized in that the lubricant (7) is thixotropic.

14. A drawer slide according to claim 1, characterized in that the lubricant (7) has a viscosity of 50 to 1500 mm²/s, preferably 100 to 1000 mm²/s.

15. A drawer slide according to claim 1, characterized in that the lubricant (7) has a surface tension of 20 to 22 mN/m, preferably 20.9 to 21.2 mN/m, at 25° C.

16. A lubricant, especially for fittings in domestic appliances, characterized in that the lubricant (7) contains boron nitride and/or a polysiloxane, and has a temperature resistance of −50° C. up to over 600° C.

17. A lubricant according to claim 16, characterized in that the lubricant (7) is powdery.

18. A lubricant according to claim 16, characterized in that the lubricant (7) is applied as a sliding paste, dispersion or suspension.

19. A lubricant according to claim 16, characterized in that the lubricant (7) contains a mixture of boron nitride and graphite.

20. A lubricant according to claim 16, characterized in that boron nitride is contained in a mass fraction w (boron nitride) of between 5% up to 30%, preferably a mass fraction w (boron nitride) of between 10% up to 20%.

21. A lubricant according to claim 16, characterized in that the lubricant (7) contains a silicone paste, a silicone grease and/or a silicone oil as a silicone compound.

22. A lubricant according to claim 16, characterized in that the lubricant (7) contains a polydimethylsiloxane.

23. A lubricant according to claim 16, characterized in that the lubricant comprises boron nitride and/or graphite particles, in the size range of 0.1 μm to 8 μm.

24. A lubricant according to claim 16, characterized in that the lubricant is substantially a mixture of boron nitride, graphite and silicone oil and/or silicone paste and/or silicone grease.

25. A lubricant according to claim 24, characterized in that boron nitride is contained in a mass fraction w (boron nitride) of between 20% up to 30%, preferably a mass fraction w (boron nitride) of 25%, graphite in a mass fraction w (graphite) of between 20% up to 30%, preferably a mass fraction w (graphite) of 25%, and silicone oil in a mass fraction w (silicone oil) of between 45% up to 55%, preferably a mass fraction w (silicone oil) of 50%.

26. A lubricant according to claim 23, characterized in that the boron nitride and/or graphite particles are resistant to domestic and industrial dishwashers after having been worked into the surfaces of the frictional elements.

27. A fitting, especially for domestic appliances, characterized in that the fitting is lubricated with a lubricant (7) which contains boron nitride and/or a polysiloxane and has a temperature resistance of −50° C. up to and over 600° C.

28. A fitting according to claim 27, characterized in that the fitting is lubricated with a lubricant (7) according to one of the claims 16 to 26.

29. A fitting according to claim 27, characterized in that the fitting is a hinge for the door of a domestic appliance for example.

30. A fitting according to claim 27, characterized in that the fitting is a hinged fitting for a hinge of a domestic appliance for example.

31. A fitting according to claim 27, characterized in that the fitting is a drawer slide for a cooking-product carrier in food preparation appliances or for drawer slides in food storage devices.
